(19) United States
(12) Patent Application Publication
(10) Pub. No.: US 2011/0022600 A1
(43) Pub. Date: Jan. 27, 2011

(54) METHOD OF DATA RETRIEVAL, AND SEARCH ENGINE USING SUCH A METHOD

(75) Inventors: Saket SATHE, Ecublens (CH); Gleb Skobeltsyn, Ecublens (CH)

Correspondence Address: BLANK ROME LLP, WATERGATE, 600 NEW HAMPSHIRE AVENUE, N.W., WASHINGTON, DC, 20037, US

(73) Assignee: Ecole Polytechnique Federale de Lausanne EPFL, Lausanne (CH)

(21) Appl. No.: 12/507,381

(22) Filed: Jul. 22, 2009

(51) Int. Cl. G06F 7/10; G06F 17/30

(52) U.S. Cl. 707/742; 707/E17.109

(57) ABSTRACT

A method of data retrieval from a data repository in response to a query having either list of keywords and/or list of attribute-value pairs, the method comprising the steps of:
providing an inverted index generated from the data repository, the inverted index indicating the attribute with which each term is encountered in each entity when such an attribute is available;
retrieving data from the inverted index by searching said inverted index based on said attribute-value pairs or keywords;
providing scores to entities.
   A method of forming an inverted index from a data repository and a search engine for retrieval of data from a data repository is also provided.

### FIELD OF THE INVENTION

The present invention relates to a method of data retrieval from a data repository in response to a query using a modified version of an inverted index generated from the data repository and involving a specific scoring approach. The invention also relates to the corresponding search engine and method of forming an inverted index.

### BACKGROUND OF THE INVENTION

The use of efficient search engines and highly sophisticated indexing techniques is wide spread in information retrieval systems. Information retrieval systems such as Web search systems locate documents amongst billions of possible documents on the basis of query terms. In order to achieve this, document indexes are created. Considering the huge number of documents and references that are potentially available on the Web, such tools are very useful to improve the search efficiency and accuracy.

The most popular data structure used for answering queries efficiently in a Web search engine is an inverted index. A standard inverted index maintains a number of posting lists for all terms found in the document collection. The posting list of a given term stores document identifiers of all documents that contain the term. Inverted indexes are known to be very efficient for processing queries that are specified as lists of terms (keyword queries).

Although, known inverted index structures and related query processing work best for plain text documents containing no structured information, they offer limited functionalities in terms of processing structured (attribute-value) queries or queries containing a mixture of keywords and attribute-values. Thus the resulting performance and features obtained from using standard inverted indexes are therefore also limited.

EP1862916 relates to information retrieval. Here, it is proposed to create new fields in the documents to store feedback information. This information comprises query terms used in a particular search as well as information about whether a particular document retrieved is given positive or negative feedback for example. Indexes are created on the basis of this feedback information in addition to other available information. As a result, relevance of search results is improved. Multiple fields of information are available for given documents (such as abstract fields, title fields, anchor text fields, etc). A search algorithm which deals with multiple fields as well as multiple query terms and which provides for differential weighting of document fields is then used. Such indexing tools do not provide satisfactory results to limit the number of references given in the search result list nor to present these references according to a reliable ranking.

US2003/0225779 describes an example of an inverted index. This document describes a system and method for generating an inverted index and processing search queries using the inverted index. To increase efficiency for queries having multiple numeric range conditions, numeric attributes are tokenized into a plurality of tokens based on their binary value. The tokens become keys in the inverted index. A numeric range query is translated into a query on multiple tokens and combining two or more range queries on different attributes becomes a simple merge document identification list. The described tools are however specifically provided for use with numeric attributes.

US20050210006A1 discloses a field-weighted search which combines statistical information for each term across document fields in a suitably weighted fashion. Both field-specific term frequencies and field and document lengths are considered to obtain a field-weighted document weight for each query term. Each field-weighted document weight can then be combined in order to generate a field-weighted document score that is responsive to the overall query.

US20080263032A1 discloses a method for analyzing and indexing an unstructured or semi-structured document according to one embodiment which includes receiving an unstructured or semi-structured document; converting the document to one or more text streams; analyzing the one or more text streams for identifying textual contents of the document; analyzing the one or more text streams for identifying logical sections of the document; associating the textual contents with the logical sections; indexing the textual contents and their association with the logical sections; and storing the resulting index in a data storage device.

US2009083214A1 discloses index structures and query processing framework that enforces a given threshold on the overhead of computing conjunctive keyword queries.

US20030078915A1 discloses a keyword search which provides generalized matching capabilities on a relational database. This is enabled by performing pre-processing operations to construct inverted list lookup tables based on data record components at an interim level of granularity, such as column location. Prefix information is in the inverted list stored for each keyword, keyword sub-string, or stemmed version of the keyword.

### SUMMARY OF THE INVENTION

A general aim of the invention is to provide an improved inverted index and search engine.

A further aim of the invention is to provide such an inverted index and method of data retrieval, which offers more possibilities for searches.

Still another aim of the invention is to provide such an inverted index, search engine and method of data retrieval, which facilitates searching operations.

Yet another aim of the invention is to provide an improved inverted index, search engine and method of data retrieval allowing providing more accurate results.

Yet another aim of the invention is to provide search functionalities for a collection of documents which describe entities, where a single entity is represented by a set of attribute-value pairs.

These aims are achieved thanks to the method of data retrieval and search engine defined in the claims.

There is accordingly provided a method of data retrieval from a data repository in response to a query specified by a list of keywords and/or by a list of attribute-value pairs, the method comprising the steps of:

providing an inverted index generated from the data repository, the inverted index indicating an attribute with which each term is encountered in each entity when such an attribute is available;

retrieving data from the inverted index by searching said inverted index based on said list of keywords and/or said attribute-value pairs;

providing scores to entities by giving higher scores to entities wherein the values are associated with the same attributes as specified in the query and wherein the values are associated with popular attributes.

The method enables answering user queries over very large collections of documents containing structured and unstructured data. The structured data preferably involves attribute-value pairs. The method enables using queries containing structured information in the form of attribute-value pairs. Moreover, the method requires reduced computer resources and provides accurate results in reduced time.

The attributes can be explicit in the documents, for example in structured or semi-structured documents where many terms are tagged with an attribute, such as in many XML documents. Other attributes can also be implicit or determined from the context.

This feature allows using the invention for pre-filtering, for instance to select a constant sub-set of documents in a repository containing a very large number of documents. For example, a first stage filtering allowing the selection of two hundred documents out of a collection containing billions of documents. In such a case, a further ranking method may be used for a further selection among the pre-selected documents.

In a preferred embodiment, the scoring of document d based on Query Q is provided by the relation:

Score(Q,d)=score(A_{Q},d)+score(K_{Q},d),

after partitioning the query Q into attribute-value predicates A_{Q} and keyword predicates K_{Q}.

In a variant, the scoring step allows providing scores to entities by giving higher scores to entities in which the values are associated with popular (or important) attributes.

In an advantageous embodiment, the popularity is obtained from a popularity table. Attributes that are more popular may be defined by popularity data. Such popularity data may be obtained from a popularity table that may be based for instance on user feedback, or on a priori knowledge. Popularity data (or importance data) could also be learned using machine learning/artificial intelligence techniques.

For example, it is a priori known that the attribute “name” is important. Therefore, if a user gives a query with the term “brown”, any entity in which this term is associated with the attribute “name” (such as name=“James Brown”) will be given a higher score than other documents in which the term “brown” is used only, say, in a “comment” attribute.

An even higher score will be given to this entity if the user had specifically entered a query specifying “name” as attribute (such as name=“brown”). However, even in this case, other documents in which “brown” is present in relation with another attribute (for example “comment”, or without any attribute) are not automatically disregarded, but only given a lower score.

According to another aspect, the invention also provides a method of forming an inverted index from a data repository comprising the steps of:

accessing a plurality of entities;

for each entity, identifying a plurality of terms comprised in said entity;

arranging an inverted index indicating, for each term, an attribute with which each term is encountered in each entity when such an attribute is available.

when no attribute is available for a given value, the index does not store any attribute for the corresponding value.

The invention further provides a search engine for retrieval of data from a data repository in response to a query specified by a list of keywords and/or a list of attribute-value pairs, comprising:

an access to an inverted index generated from the data repository, the inverted index indicating the attribute with which each term is encountered in each entity when such an attribute is available;

means for retrieving data from the inverted index by searching said inverted index based on said list of keywords or list of attribute-value pairs;

means for providing scores to entities by giving higher scores to entities in which the values are associated with the same attributes as specified in the query and wherein the values are associated with popular attributes.

In an advantageous embodiment, the means for providing scores are connectable to a popularity table defining the popularity of at least some attributes.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which:

FIG. 1 is a schematic diagram showing the structure of a posting list in accordance with the invention;

FIG. 2 illustrates a flow diagram illustrating the main steps required for indexing data using an inverted index which is shown in FIG. 6;

FIG. 3 is a schematic diagram showing an example architecture for the indexing process using an inverted index in accordance with the invention;

FIG. 4 illustrates a flow diagram illustrating the main steps of a search using a posting list as shown in FIG. 1 and an inverted index as shown in FIG. 6;

FIG. 5 is a schematic diagram showing the architecture of a search engine for use with an inverted index in accordance with the invention; and

FIG. 6 is a schematic diagram showing the structure of an inverted index in accordance with the invention.

### DETAILED DESCRIPTION OF THE INVENTION

In the following description, the term “entity” is used to denote a document containing semi-structured information in the form of attribute-value pairs and possibly free (plain) text. However, the skilled person in the art understands that the proposed invention can be used for a more general case of a large collection of semi-structured documents (including for example, RDF documents).

The method and tools of the invention are conceived to enable dealing with environments in which most documents (entities) are short entity profiles that often contain structural information such as attribute names. The methods and tools are also suitable for queries including not only keywords but also attribute-value pairs as predicates or any combination of the two.

Thus, the preferred query language also supports the use of structured information and requires a dedicated indexing structure.

The indexing structure is described based on the example given in Table 1. For clarity and ease of understanding, this example involves a small number of data. The skilled man in the art understands that real cases generally imply much larger amount of data, for which important computing resources are required.

TABLE 1
example of entities

| Entity 1 | Entity 2 | Entity 3 |
|---|---|---|
| Name: John Adams | Title: EPFL | Name: CERN Research |
| Affiliation: EPFL | Country: Switzerland | Center |
| Comment: John lives in | Established: 1853 | Place : Geneva, |
| Lausanne, Switzerland | President: P. Aebischer | Switzerland |
| | Comment: John Adams | |
| | works here | |

Query Q₁: John Adams

Query Q₂: name=“John Adams” EPFL

Query Q₃: name=Adams Affiliation=EPFL

Recall, each entity contains attributes associated or linked to values. For instance, in Entity 1, the attribute “Name” is linked to “John Adams”, the attribute “Affiliation” corresponds to “EPFL” and the attribute “Comment” corresponds to “John lives in Lausanne, Switzerland”. Entity 2 and 3 contain different attributes. Entities may share similar attributes, but not necessarily with the same values.

A standard inverted index would work well for the keyword query Q₁, but would perform poorly for structured queries Q₂ and Q₃, since it operates at a term level and completely ignores the structural information in those entities. Thus, to enable support for queries containing a mixture of keywords and/or attribute-value predicates, a specific indexing solution is provided. Along with the documents in which each term is found, additional information is included about the attribute with which the given term was encountered when it is available. Generally, only unique identifiers for documents (entities), terms, and attributes are stored to minimize space utilisation.

Table 2 shows an example of the resulting indexing solution. For clarity and ease of understanding, the example involves a small number of data. The skilled man in the art understands that real cases generally imply much larger amount of data, for which important computing resources are required.

TABLE 2
Examples of posting lists illustrating indexing of attribute information for
each encountered term.

| | | | | |
|---|---|---|---|---|
| EPFL | Entity 1 | Entity 2 | Entity 58 | . . . |
| | affiliation | title | | |
| Adams | Entity 1 | Entity 2 | Entity 65 | . . . |
| | name | comment | | |

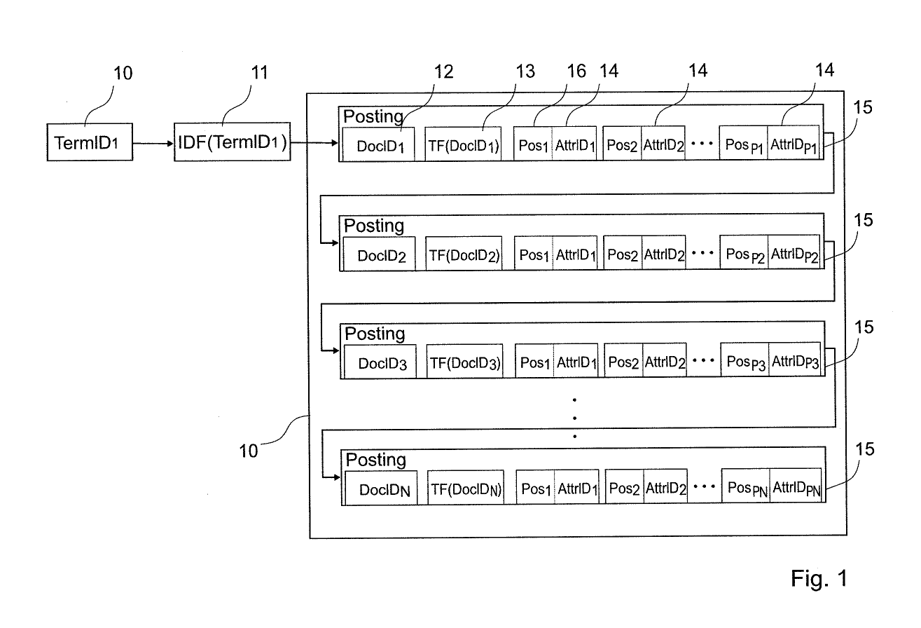

FIG. 1 illustrates the generic structure of the posting list in accordance with one embodiment of the invention. A posting list corresponds to a term 10, for instance “EPFL” or “Adams”, having an Inverse Document Frequency IDF 11.

The posting list is provided with one or more postings 15. Each posting is comprised of document identifiers 12, for instance “Entity 1”, “Entity 2”, etc. Data 13 relates to the Term Frequency TF and one or more attributes 14, for instance “affiliation”, “title”, “name”, “comment”, relate to the term in a specific document at a specific position 16.

For attribute-value predicates such a posting list structure permits testing at the query time whether the term occurs in a document together with the queried attribute or with an attribute similar to the queried attribute. For example, Entity 1 would match the query Q₃ with a high score not only because it contains keywords “Adams” and “EPFL” but also due to matching attribute information. At the same time keyword predicates are supported as in a standard inverted index.

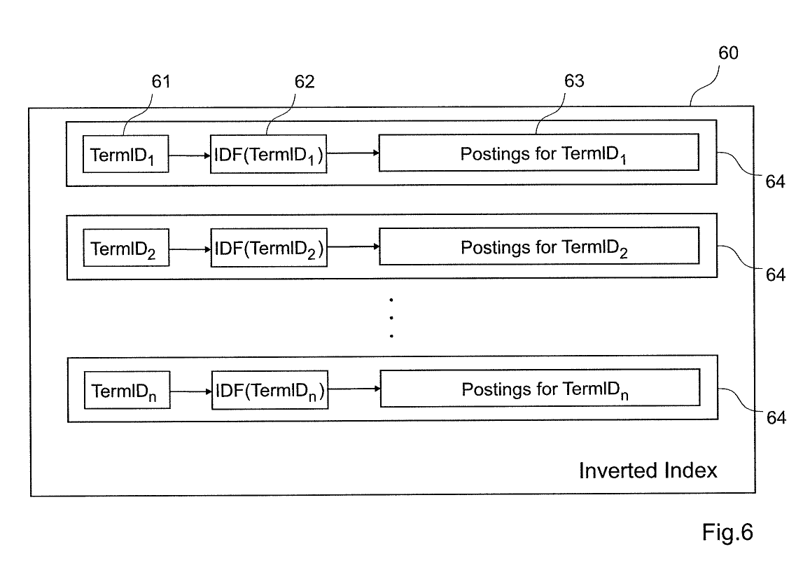

FIG. 6 illustrates the generic structure of an inverted index in accordance with one embodiment of the invention. An inverted index 60 is comprised of a plurality of posting lists 64, where each of the posting lists is associated with a corresponding term 61, Inverse Document Frequency IDF 62, and postings 63.

Another important difference with the proposed solution compared to classic Web search engines is the scoring model. Since an entity profile usually contains a relatively small number of attribute-value pairs, it does not exhibit the statistical properties of real text. For example, term frequency (number of times a term appears in a document) typically used in the prior art for scoring Web documents is ineffective for entity ranking, where even important terms often appear only once

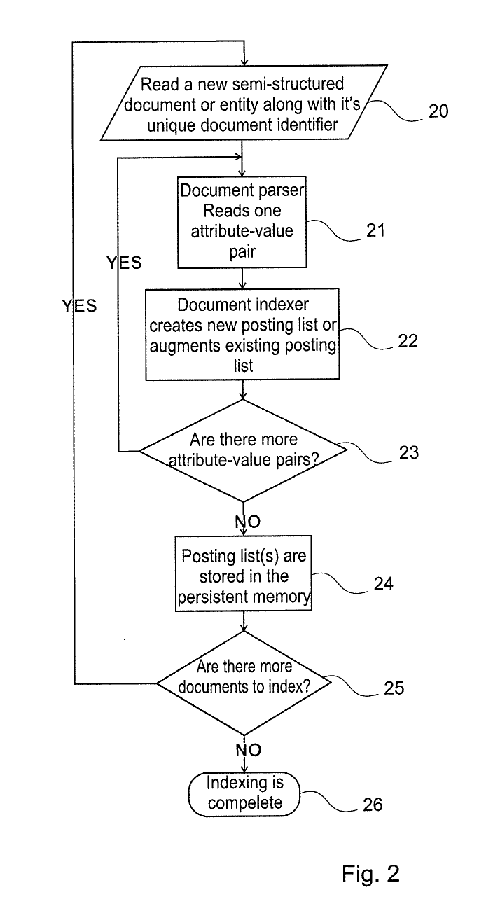

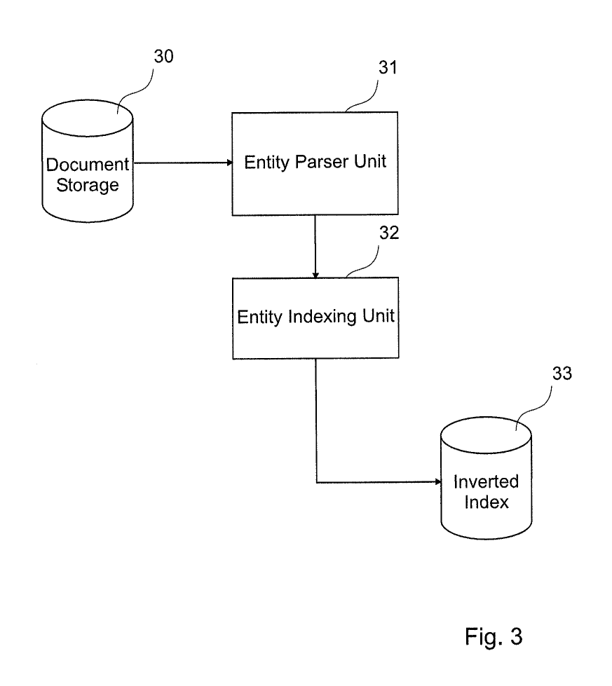

FIG. 2 illustrates as example the main steps relating to the indexing process when using such an inverted index. This Figure is considered together with FIG. 3, showing the corresponding architecture to achieve the indexing process. First, at step 20, a new document or entity is scanned along with its unique document identifier. Such a document is advantageously stored in a data repository 30 adapted for the storage of large data quantities. If an attribute-value pair is identified, it is considered by the entity parser unit 31 at step 21. At step 22, the entity indexing unit 32 checks whether there is already a posting list for all the individual terms present in the “value” part of the identified attribute-value pair, if such a posting list is not present the entity indexing unit creates a new posting list within the inverted index 33. This posting list comprises of the relevant data, for instance, a) IDF for the term, b) unique document identifier, c) attribute associated with the term being indexed, d) position of the associated attribute in the document. If a posting list already exists for the considered term, it is augmented with additional information. For instance, if a posting list exists for a given term, it may be augmented with, a) unique document identifier, b) attribute associated with the term, c) position of the associated attribute in the document. If at step 20, a single term is encountered then at step 21 it is considered as an attribute-value pair but with empty attribute keeping rest of the processing unaltered.

At step 23, a test to verify if more attribute-value pairs are to be considered is performed. If the test result is positive, the process returns to step 21. Otherwise, the posting lists are stored for further use (step 24).

Step 25 relates to a test to verify if there are more entities to be indexed. If the test result is positive, the process returns to step 20. Otherwise, the indexing process ends at step 26.

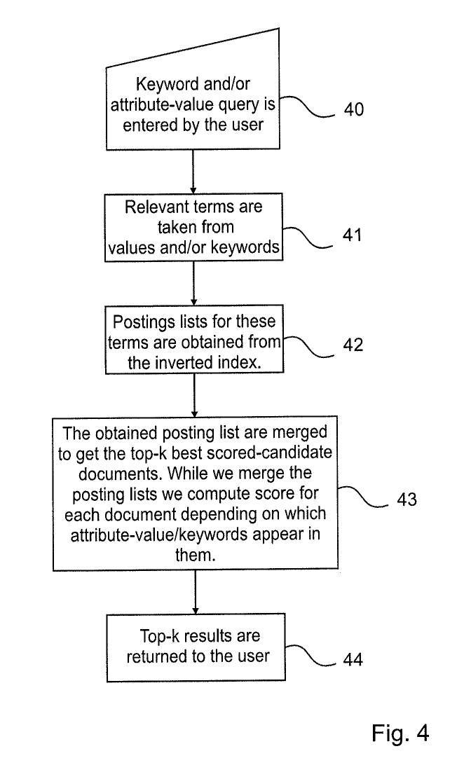

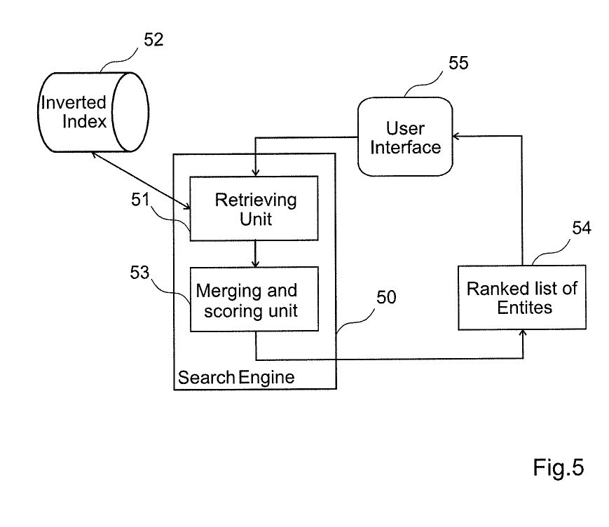

FIG. 4 illustrates the key steps for a search involving an inverted index such as the one illustrated in FIG. 6 having a set of posting lists as illustrated in FIG. 1. FIG. 4 is considered together with FIG. 5, showing the corresponding architecture of a search engine 50 to achieve the searching process. First, at step 40, keywords and/or attribute-value query is entered in the user interface 55. In a variant, an application is used to generate such keywords and/or attribute-value query. An attribute-value query shall preferably be used for optimized results. However, the method and device allows using classic queries in the form of one or more keywords without any attributes.

At step 41, all queried keywords and all terms contained in the “value” part of the attribute-value pairs contained in the query are considered by a retrieving unit 51 for obtaining the corresponding posting lists from the inverted index 52 (step 42).

At step 43, posting lists resulting from the previous step are merged by the merging and scoring unit 53 to get a ranked list of top-k best scored candidate documents. While we merge all the posting lists we compute a score for each document which appears in all posting lists (logical AND semantics) or at least one posting list (logical OR semantics).

One can apply more sophisticated scoring functions on the constant size candidate set of documents, which becomes feasible without involving time or resources penalties, since the functions need to deal with a smaller set of candidates and not all entities in the system.

Lastly, in step 44 the obtained top-k entities 54 are sent to the user, for instance at the user interface 55.

The entity search process can conclude that the query found a list of best top-k scored documents, or no documents could be found. In the first case, a ranked list of top-k entities is returned to the user. For the latter case, an empty list is returned which indicates that the entity described by the specific query does not exist or is not available.

For scoring entities, the developed solution proposes two novel scoring heuristics that benefit from the available structured information and are suitable for queries containing both types of predicates: keywords and/or attribute-value pairs.

For keyword predicates, higher scores are given to documents containing the queried keyword together with a popular attribute. Popularity ρ(a) of an attribute a may be obtained from external sources. For instance, popularity may be given in a table based on user feedback. For example, while answering the query Q₁ from Table 1, Entity 1 will get a higher score compared to the Entity 2, since the later mentions the required values in attribute “comment” which is generally less popular than attribute “name”.

For attribute-value predicates higher scores are given to entities in which the values are found in the same attributes as specified in the query. For example, for the predicate “affiliation=EPFL” Entity 1 will have a higher score than Entity 2 because it contains exactly the queried attribute-value pair.

For attribute-value predicates higher scores are given to entities in which the values are found in the similar (related) attributes as specified by the query. In this case a pre-computed matrix of attribute-attribute similarities can be used.

Formally, to evaluate the score of document d given query Q, the query is partitioned into attribute-value predicates A_{Q} and keyword predicates K_{Q}. Then, the score is given by:

Score(Q,d)=score(A_{Q},d)+score(K_{Q},d).

If term t occurs in P_{d} attributes of document d then score (K_{Q}, d) is evaluated as:

$${\sum }_{k ∈ {K}_{Q}} ( idf ( k ) \cdot {\sum }_{p ∈ {P}_{d}} ρ ( {att}_{d}^{p} ( k ) ) ) ,$$

where att^{p}_{d}(t) denotes the p^{th} attribute in which t occurs and idf(t) is the inverse document frequency of term t. Notice that a keyword occurring in a document's popular attributes contributes more to its score.

Next, the score (A_{Q}, d) is evaluated as:

$${\sum }_{a : v ∈ {A}_{Q}} ( idf ( v ) \cdot {\sum }_{p ∈ {P}_{d}} ρ ( {att}_{d}^{p} ( k ) ) \prod ( a , {att}_{d}^{p} ( v ) ) ) ,$$

where a:v is an attribute-value predicate and Π(a₁, a₂) is an indicator function, which returns 1 if a₁=a₂ or 0 otherwise. Notice that this solution ignores semantically similar but syntactically different attributes, so a fuzzy similarity measure between the attributes based on statistics is advantageously used instead of simply verifying the equivalence. The score can be used by the search engine for ranking the documents, or for filtering out documents with a low score under a given threshold for example.

What is claimed is:

1. A method of data retrieval from a data repository in response to a query having a list of keywords and/or a list of attribute-value pairs, the method comprising the steps of:
providing an inverted index generated from the data repository, the inverted index indicating the attribute with which each term is encountered in each entity when such an attribute is available;
retrieving data from the inverted index by searching said inverted index based on said list of keywords and/or said list of attribute-value pairs;
providing scores to entities by giving higher scores to entities wherein the values are associated with the same attributes as specified in the query and wherein the values are associated with popular attributes.

2. The method of data retrieval of claim 1, wherein the popularity is obtained from a popularity table.

3. The method of data retrieval of claim 1, wherein the score is used by a search engine for ranking the documents or for filtering out documents.

4. The method of data retrieval of claim 1, wherein scoring of a document d based on Query Q is obtained after partitioning the query Q into attribute-value predicates A_{Q} and keyword predicates K_{Q}.

5. A method of claim 4, wherein, scoring of said document d based on Query Q is provided by the relation:
Score(Q,d)=score(A_{Q},d)+score(K_{Q},d),
after partitioning the query Q into an Attribute-Value predicate A_{Q} and a Keyword predicate K_{Q}.

6. A method of claim 4, wherein scoring of said document d based on Query Q is provided by the relation
$${\sum }_{a : v ∈ {A}_{Q}} ( idf ( v ) \cdot {\sum }_{p ∈ {P}_{d}} ρ ( {att}_{d}^{p} ( k ) ) \prod ( a , {att}_{d}^{p} ( v ) ) ) ,$$
where a:v is an attribute-value predicate and Π(a1, a2) is an indicator function, which returns 1 if a1=a2 or 0 otherwise.

7. The method of data retrieval of claim 1, comprising the step of considering semantically similar but syntactically different attributes, and thus employing a fuzzy similarity measure between the attributes.

8. A method of claim 4, wherein scoring of said document d based on Query Q is provided by the relation
$${\sum }_{k ∈ {K}_{Q}} ( idf ( k ) \cdot {\sum }_{p ∈ {P}_{d}} ρ ( {att}_{d}^{p} ( k ) ) ) ,$$
where att^{p}_{d}(t) denotes the p^{th} attribute in which t occurs and idf(t) is the inverse document frequency of term t, wherein a keyword occurring in a document's popular attributes contributes more to its score.

9. A method of forming an inverted index from a data repository comprising the steps of:
accessing a plurality of entities;
for each entity, identifying a plurality of terms comprised in said entity;
arranging an inverted index indicating, for each term, an attribute with which each term is encountered in each entity when such an attribute is available.

10. A search engine for retrieval of data from a data repository in response to a query having a list of keywords and/or a list of attribute-value pairs, comprising:
an access to an inverted index generated from the data repository, the inverted index indicating the attribute with which each term is encountered in each entity when such an attribute is available;
means for retrieving data from the inverted index by searching said inverted index based on said list of keywords and/or said list of attribute-value pairs;
means for providing scores to entities by giving higher scores to entities wherein the values are associated with the same attributes as specified in the query and wherein the values are associated with popular attributes.

11. The search engine of claim 10, wherein the means for providing scores are adapted to determine a score of a document d based on a Query Q and document d after partitioning the query Q into attribute-value predicates A_{Q} and keyword predicates K_{Q}.

12. The search engine of claim 11, wherein the means for providing scores are adapted to determine a score of a document d based on a Query Q using the relation:
Score(Q,d)=score(A_{Q},d)+score(K_{Q},d),
after partitioning the query Q into an Attribute-Value predicate A_{Q} and a Keyword predicate K_{Q}.

13. The search engine of claim 12, wherein the means for providing scores enable giving higher scores to entities in which the values are associated with popular attributes.

14. The search engine of claim 10, comprising means for employing a fuzzy similarity measure between the attributes.

15. The search engine of claim 12, wherein the means for providing scores are connectable to a popularity table defining the popularity of at least some attributes.

16. A method of data retrieval from a data repository in response to a query having a list of keywords and/or a list of attribute-value pairs, the method comprising the steps of:
providing an inverted index generated from the data repository, the inverted index indicating the attribute with which each term is encountered in each entity when such an attribute is available;
retrieving data from the inverted index by searching said inverted index based on said list of keywords and/or said list of attribute-value pairs;
providing scores to entities by giving higher scores to entities wherein the values are associated with similar attributes as specified in the query and wherein the values are associated with popular attributes.

17. A search engine for retrieval of data from a data repository in response to a query having a list of keywords and/or a list of attribute-value pairs, comprising:
an access to an inverted index generated from the data repository, the inverted index indicating the attribute with which each term is encountered in each entity when such an attribute is available;
means for retrieving data from the inverted index by searching said inverted index based on said list of keywords and/or said list of attribute-value pairs;
means for providing scores to entities by giving higher scores to entities wherein the values are associated with similar attributes as specified in the query and wherein the values are associated with popular attributes.

18. The search engine of claim 17, wherein the means for providing scores are connectable to a popularity table defining the popularity of at least some attributes.

19. The search engine of claim 17, wherein the means for providing scores are adapted to determine a score of a document d based on a Query Q and document d after partitioning the query Q into attribute-value predicates A_{Q} and keyword predicates K_{Q}.

20. The search engine of claim 19, wherein the means for providing scores are adapted to determine a score of a document d based on a Query Q using the relation:
Score(Q,d)=score(A_{Q},d)+score(K_{Q},d),
after partitioning the query Q into an Attribute-Value predicate A_{Q} and a Keyword predicate K_{Q}.
